(19) United States
(12) Patent Application Publication
(10) Pub. No.: US 2026/0055740 A1
(43) Pub. Date: Feb. 26, 2026

(54) LIQUID-COOLED CYLINDER HEAD

(71) Applicant: AVL LIST GMBH, Graz (AT)

(72) Inventors: Andreas Zurk, Weinburg (AT); Martin Klampfer, Hitzendorf (AT)

(21) Appl. No.: 19/105,543

(22) PCT Filed: Aug. 23, 2023
(86) PCT No.: PCT/AT2023/060285

§ 371 Date: Feb. 21, 2025

(30) Foreign Application Priority Data
Aug. 23, 2022 (AT) A 50649/2022

(51) Int. Cl. F02F 1/14

(52) U.S. Cl. CPC F02F 1/14; F02F 2200/06

(57) ABSTRACT

The invention relates to a liquid-cooled cylinder head for an internal combustion engine with a top-down cooling concept, having a lower cooling chamber adjoining a fire deck and an upper cooling chamber which is separated from the lower cooling chamber by an intermediate deck and which is largely further away from the fire deck than the lower cooling chamber, wherein the lower cooling chamber and the upper cooling chamber are connected fluidically together in the region of a receiving sleeve, arranged centrally with respect to the cylinder, for a component leading centrally into a combustion chamber, via at least one annular overflow channel, formed by an overflow opening and the receiving sleeve, in the intermediate deck, wherein a diameter of the substantially circular overflow opening is larger than an outside diameter of the receiving sleeve, having an inlet channel arrangement with at least two inlet openings leading into the combustion chamber and an outlet channel arrangement with at least two outlet openings leading into the combustion chamber. In order to achieve optimal cooling of thermally critical regions, the invention provides that the overflow opening is arranged eccentrically with respect to the receiving sleeve, wherein a central axis of the overflow opening, extending through a center of the overflow opening, is spaced apart from the sleeve axis of the receiving sleeve.

The invention relates to a liquid-cooled cylinder head for an internal combustion engine with a top-down cooling concept, in particular having multiple cylinders, having a lower cooling chamber adjoining a fire deck and an upper cooling chamber which is separated from the lower cooling chamber by an intermediate deck and which is predominantly further away from the fire deck than the lower cooling chamber, wherein the lower cooling chamber and the upper cooling chamber are flow-connected to one another in the region of a receiving sleeve arranged centrally in relation to the cylinder, preferably concentrically or parallel to the cylinder axis, for a component opening centrally into a combustion chamber via at least one annular overflow channel formed by an overflow opening and the receiving sleeve in the intermediate deck, wherein a diameter of the substantially circular overflow opening is larger than an outer diameter of the receiving sleeve, having an inlet channel arrangement with at least two inlet openings opening into the combustion chamber and an outlet channel arrangement with at least two outlet openings opening into the combustion chamber.

The top-down cooling concept is a cooling concept in which the coolant first flows through the upper cooling chamber, which is further away from the fire deck, and only then through the lower cooling chamber, which is close to the fire deck.

A cylinder head for an internal combustion engine with a top-down cooling system is known from WO 2020/188071 A1, which has an upper cooling chamber adjoining an intermediate deck and a lower cooling chamber adjoining a fire deck. An annular transfer opening is provided between the upper and lower cooling chambers in the region of a central receiving sleeve for an injection or ignition device. The transfer opening is concentric to the receiving sleeve.

DE 103 50 394 A1 describes a cylinder head for a liquid-cooled multi-cylinder internal combustion engine having a cooling chamber arrangement adjoining a fire deck, which is divided by an intermediate deck into a lower partial cooling chamber and an upper partial cooling chamber. The two partial cooling chambers are flow-connected to each other by overflow openings in the region of a receiving opening for a sleeve for a central fuel injection device, which are designed as bulges in the receiving opening. Similar cooling arrangements are known from EP 2998 555 A1, EP 3 333 398 A1 or WO 2012/004340 A1.

It is the object of the invention to achieve optimum cooling of thermally critical areas of the cylinder head in a simple manufacturing process.

According to the invention, this is achieved in an internal combustion engine of the type mentioned at the beginning in that the overflow opening is arranged eccentrically in relation to the receiving sleeve, wherein a central axis of the overflow opening, extending through a center point of the overflow opening, is spaced apart from the sleeve axis of the receiving sleeve, wherein the central axis of the overflow opening and the sleeve axis are preferably arranged parallel to one another.

Preferably, the distance between the sleeve axis and the central axis of the overflow opening is less than half the outer diameter of the receiving sleeve.

In order to achieve optimum cooling, it is advantageous if the central axis of the overflow opening is arranged on the outlet side and/or is arranged closer to an outlet valve bridge between two outlet openings than to an inlet valve bridge between two inlet openings. In other words, the eccentric overflow opening is oriented in the direction of the outlet valve bridge between the two outlet valves.

The overflow opening can be formed by casting and/or by machining the intermediate deck.

The eccentrically designed overflow opening results in an overflow channel with an eccentric overflow cross-section, which is larger on the outlet side than on the inlet side. As a result, improved cooling can be achieved with low coolant quantities.

In one embodiment variant of the invention, it is provided that the intermediate deck has at least one local intermediate deck elevation, preferably produced by casting, in the region of the overflow opening. In this way, the cooling section is extended in the direction of the cylinder axis, thereby improving the cooling water flow in the direction of the fire deck. Furthermore, the raised intermediate deck can increase the structural rigidity by connecting a vertical support structure of the cylinder head to the intermediate deck. The vertical support structure connects the oil deck with the fire deck in a vertical direction within the cylinder head. The vertical support structure extends between the valve guides and/or the inlet and outlet openings and the overflow opening. A similar support structure is known, for example, from AT 522 060 B1.

Advantageously, the intermediate deck elevation is annular and arranged concentrically around the overflow opening. Advantageously, the intermediate deck elevation can be arranged between the inlet openings or outlet openings and the overflow opening. The intermediate deck elevation is therefore located in an annular shape around the receiving sleeve between the inlet and outlet openings and the overflow opening and is integrated into the vertical support structure of the cylinder head.

In order to reduce losses during flow transfer between the two cooling chambers, it is advantageous if at least one intermediate deck elevation has an inlet chamfer on an inner side adjoining the overflow opening in the region of an upper side facing away from the intermediate deck.

In a further embodiment of the invention, it is provided that the overflow opening has at least one bulge, wherein the bulge is preferably arranged in the region of a valve bridge. In this context, a bulge is to be understood as a cross-sectional widening that deviates outwards from the circular shape of the overflow opening. This makes it possible to increase the flow rate of the coolant passing between the upper cooling chamber and the lower cooling chamber, thereby improving heat dissipation.

The entire transfer cross-section for coolant transfer between the upper cooling chamber and the lower cooling chamber results from a combination of machined and cast transfers in the region of the receiving sleeve, i.e. through the circular eccentric transfer opening and the additional bulges.

The invention is explained in more detail below with reference to the non-limiting exemplary embodiments shown in the figures, wherein:

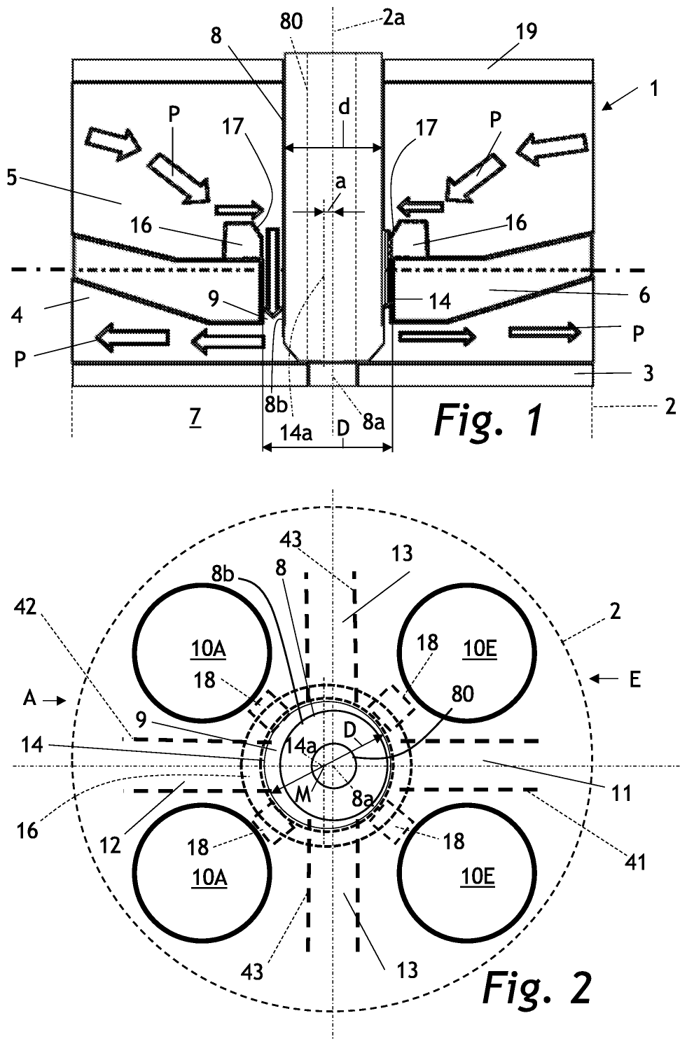

FIG. 1 shows a cylinder head according to the invention in a first embodiment variant in a sectional view along line I-I in FIG. 2;

FIG. 2 shows this cylinder head in a section along line II-II in FIG. 1; and

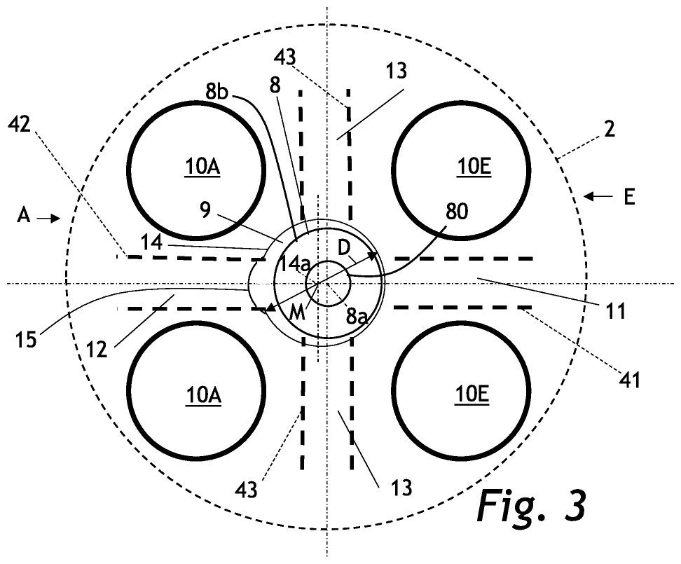

FIG. 3 shows the cylinder head in a second embodiment variant in a sectional view analogous to FIG. 2.

FIGS. 1 and 2 show a cylinder head 1 for an internal combustion engine with one or more cylinders 2. The cylinder head 1 has a lower cooling chamber 4 adjoining a fire deck 3 and an upper cooling chamber 5 spaced from the fire deck 3, which is separated from the lower cooling chamber 4 by an intermediate deck 6. The terms “bottom” and “top” refer to the illustration shown in FIG. 1 and not to the actual installation position of the internal combustion engine during operation. The actual installation position of the cylinder head 1 can therefore deviate from the orientation shown in FIG. 1.

The upper cooling chamber 5 is predominantly further away from the firing deck 3 than the lower cooling chamber 4. The lower cooling chamber 4 and the upper cooling chamber 5 are flow-connected to one another in the region of a receiving sleeve 8, arranged centrally in relation to the cylinder 2, for example concentrically and parallel to the cylinder axis 2a, for a component 80 opening centrally into a combustion chamber 7, such as an injection device or an ignition device, via at least one overflow channel 9 in the intermediate deck 6. The cylinder head 1 has two inlet openings 10E opening into the combustion chamber 7 for an inlet channel arrangement, not shown further, on an inlet side E of the cylinder head 1 and two outlet openings 10A opening into the combustion chamber 7 for an outlet channel arrangement, not shown further, on an outlet side A of the cylinder head 1.

Inlet valve bridges 11 are formed between the inlet openings 10E and outlet valve bridges 12 are formed between the outlet openings 10A. An inlet/outlet valve bridge 13 is located between each inlet opening 9 and an outlet opening 10. The lower cooling chamber 4 has a bridge channel 41, 42, 43 in each case in the region of the inlet valve bridge 11, in the region of the outlet bridge 12 and in the region of the inlet/outlet valve bridges 13. The bridge channels 41, 42, 43 are indicated by dashed lines in FIG. 2.

The overflow channel 9 between the upper cooling chamber 5 and the lower cooling chamber 4 is substantially oriented in the direction of the cylinder axis 2a. It is formed by a substantially circular overflow opening 14 arranged in the intermediate deck 6 and the, for example, cylindrical outer surface 8b of the receiving sleeve 8. The overflow opening 14 can be molded by casting into the cylinder head 1 and/or formed by machining the intermediate deck 6.

The overflow opening 14 of the overflow channel 9 is arranged eccentrically in relation to the sleeve axis 8a of the receiving sleeve 8. The overflow channel 9 has an essentially annular, eccentric cross-section. The diameter D of the overflow opening 14 is larger than the outer diameter d of the receiving sleeve 8. A central axis 14a of the overflow opening 14 extending through the center M of the circular overflow opening 14 is spaced from the sleeve axis 8a of the receiving sleeve 8. The central axis 14a of the overflow opening 14 and the sleeve axis 8a are arranged substantially parallel to each other, for example. The central axis 14a of the overflow opening 14 is arranged on the outlet side A. In other words, the central axis 14a is arranged closer to the outlet valve bridge 12 between the two outlet openings 10A than to the inlet valve bridge 11 between the two inlet openings 10E. The distance a between the sleeve axis 8a and the central axis 14a is less than half the outer diameter d of the receiving sleeve 8, in particular less than a quarter of the outer diameter d of the receiving sleeve 8. The eccentrically arranged overflow opening 14 results in an eccentrically shaped overflow channel 9, which has a larger cross-section on the outlet side A than on the inlet side E (see FIG. 2).

Furthermore, at least one intermediate deck elevation 16, for example produced by casting, can be arranged between an inlet opening 10E and/or an outlet opening 10A and the overflow opening 14. FIG. 1 and FIG. 2 show an embodiment in which an intermediate cover elevation 16 arranged in an annular shape and concentrically around the overflow opening 14 and the receiving sleeve 8 is provided between the outlet openings 10A or inlet openings 10E and the overflow opening 14. The position of the intermediate deck elevation 16 is indicated by dashed lines in FIG. 2. The intermediate deck elevation 16 connects a vertical support structure 18 of the cylinder head 1 to the intermediate deck 6. This allows the structural rigidity of the cylinder head 1 to be increased. The vertical support structure 18 connects the oil deck 19 to the fire deck 4 in a vertical direction within the cylinder head 1 and extends between the valve guides and/or the inlet 10E and outlet openings 10A and the overflow opening 14.

As can be seen from FIG. 1, in the exemplary embodiment, the intermediate deck elevation 16 has an inlet chamfer 17 on an inner side adjacent to the overflow opening 14 in the region of an upper side facing away from the intermediate deck 6 in order to minimize the flow losses during flow transfer between the upper cooling chamber 5 and the lower cooling chamber 4.

The intermediate deck elevations 16 extend the cooling distance in the direction of the cylinder axis 2a and improve the cooling water flow in the direction of the fire deck 4. Furthermore, the raised intermediate deck 16 increases the structural rigidity.

The overflow opening 14 can have at least one bulge 15 in the region of a valve bridge, for example the outlet valve bridge 12, in order to increase the flow rate of the coolant passing between the upper cooling chamber 5 and the lower cooling chamber 4 and thus to improve heat dissipation. The bulge 15 is indicated by dashed lines in FIG. 3. The intermediate deck elevation and vertical support structure are not shown in FIG. 3.

The cylinder head 1 has a so-called top-down cooling concept. A top-down cooling concept is a cooling concept in which the coolant first flows through the upper cooling chamber 5, which is further away from the fire deck, and only then through the lower cooling chamber 4, which is close to the fire deck.

The coolant flows radially in the cylinder head 2 in accordance with the arrows P in the upper cooling chamber 5 in the direction of the receiving sleeve 8 and reaches the lower cooling chamber 4 via the eccentrically designed overflow channel 9. The receiving sleeve 8 and the component 80 received by the receiving sleeve 8 are cooled in the process. The coolant flows radially outwards through the bridge channels 41, 42, 43 of the lower cooling chamber 4, wherein the thermally critical areas of the outlet valve bridge 12, but also the inlet valve bridge 11 and inlet/outlet valve bridges 13 are cooled (FIG. 1). Due to the eccentric shape of the overflow channel 9, considerably more coolant flows on the outlet side A through the overflow channel 9 from the upper cooling chamber 5 into the lower cooling chamber 4 than on the inlet side E.

1. A liquid-cooled cylinder head for an internal combustion engine with a top-down cooling concept, comprising: a lower cooling chamber adjoining a fire deck and an upper cooling chamber which is separated from the lower cooling chamber by an intermediate deck and which is predominantly further away from the fire deck than the lower cooling chamber, wherein the lower cooling chamber and the upper cooling chamber are flow-connected to one another in the region of a receiving sleeve arranged centrally in relation to the cylinder, for a component opening centrally into a combustion chamber via at least one annular overflow channel formed by an overflow opening and the receiving sleeve in the intermediate deck, wherein a diameter of the substantially circular overflow opening is larger than an outer diameter of the receiving sleeve, an inlet channel arrangement with at least two inlet openings opening into the combustion chamber and an outlet channel arrangement with at least two outlet openings opening into the combustion chamber, wherein the overflow opening is arranged eccentrically in relation to the receiving sleeve, wherein a central axis of the overflow opening, extending through a center point of the overflow opening, is spaced apart from the sleeve axis of the receiving sleeve.

2. The cylinder head according to claim 1, wherein the distance between the sleeve axis and the central axis of the overflow opening is less than half the outer diameter of the receiving sleeve.

3. The cylinder head according to claim 1, wherein the overflow opening of the overflow channel is formed by machining the intermediate deck.

4. The cylinder head according to claim 1, wherein the intermediate deck has at least one intermediate deck elevation in the region of the overflow opening.

5. The cylinder head according to claim 4, wherein the intermediate deck elevation is arranged between inlet openings, outlet openings and the overflow opening.

6. The cylinder head according to claim 4, wherein the intermediate deck elevation is annular and arranged concentrically around the overflow opening.

7. The cylinder head according to claim 4, wherein the intermediate deck elevation has an inlet chamfer on an inner side adjoining the overflow opening in the region of an upper side facing away from the intermediate deck.

8. The cylinder head according to claim 4, wherein the intermediate deck elevation connects a vertical support structure of the cylinder head to the intermediate deck.

9. The cylinder head according to claim 1, wherein the central axis of the overflow opening is arranged on the outlet side.

10. The cylinder head according to claim 1, wherein the overflow opening has at least one bulge.

11. The cylinder head of claim 1, wherein the receiving sleeve is arranged concentrically or parallel to the cylinder axis.

12. The cylinder head of claim 1, wherein the central axis of the overflow opening and the sleeve axis are arranged parallel to one another.

13. The cylinder head of claim 1, wherein the distance between the sleeve axis and the central axis of the overflow opening is less than a quarter of half the outer diameter of the receiving sleeve.

14. The cylinder head of claim 1, wherein the central axis of the overflow opening is arranged closer to an outlet valve bridge between two outlet openings than to an inlet valve bridge between two inlet openings.

15. The cylinder head of claim 1, wherein the cylinder head is designed for an internal combustion engine with multiple cylinders:

16. The cylinder head of claim 4, wherein the intermediate deck elevation is produced by casting.

17. The cylinder head of claim 10, wherein the bulge is arranged in the region of an exhaust valve bridge
